(19) United States
(12) Patent Application Publication
(10) Pub. No.: US 2003/0037411 A1
(43) Pub. Date: Feb. 27, 2003

(54) Vehicular door checker structure

(76) Inventor: Seung-Woo Seo, Kyungki-Do (KR)

Correspondence Address: Pennie & Edmonds, LLP, 3300 Hillview Avenue, Palo Alto, CA, 94304, US

(21) Appl. No.: 10/085,232

(22) Filed: Feb. 26, 2002

(30) Foreign Application Priority Data
Aug. 21, 2001 (KR) 2001-50355

(51) Int. Cl. E05C 17/18

(52) U.S. Cl. 16/86 C

(57) ABSTRACT

A vehicular door checker structure adapted to enable a change in the shape of a slider elastically supporting the checker arm in an elastic guide member to absorb tolerances in the guide member supporting the slider.

### FIELD OF THE INVENTION

The present invention relates to a vehicular door checker structure, and more particularly to a vehicular door checker structure adapted to change the shape of a slider elastically supporting a checker arm in an elastic guide member to improve ease of assembly and operation.

### BACKGROUND OF THE INVENTION

Generally, a vehicular door is rotably hinged to a filler panel of a vehicular body to provide an easy opening and closing thereof. The door is formed at the hinge with a door checker to provide a gradual opening by way of adjustment of the opening angle and a so-called staccato or articulated feeling by means of adequate maintenance of tension. The door checker also helps maintain a continued open state when the door is opened at a predetermined angle to enable passengers to get in and out of a vehicle safely.

In other words, the door checker 10, as shown in FIG. 1, includes a mounting bracket 12 mounted to an internal side of a body filler panel, a checker arm 14 rotatively coupled, via a fastening pin 12a, to the mounting bracket 12, and an elastic guide member 16 mounted on the internal panel of the door to movably accommodate the checker arm 14 and to provide a staccato or articulated feeling to elastically support the checker arm 14 for opening or closing of the door.

The checker arm 14, coupled via the fastening pin 12a at the mounting bracket 12, integrally includes an extension part 14a. The central cross-section of part 14a extends to an enlarged shape, a groove 14b, where the cross-section thereof becomes tapered posterior to the extension part 14a, and a hitching support part 14c supportively hitched by the back side of the elastic guide member 16 to be prevented from detachment from the elastic guide member 16 at one end past the groove 14b.

The elastic guide member 16 includes a first housing plate 16a with surface thereof attached to the internal side of an internal panel of the door and a second housing plate 16b with upper and lower parts thereof attached to the first housing plate 16a, and a center portion thereof upwardly bent to form a space of predetermined size. Sliders 20 are installed in each internal space formed by the first and second housing plates 16a, 16b and are elastically supported via cushion members 18. The elastic guide member 16 includes first through holes 16c formed at the top and bottom of the internal panel of the door for screw mounting, and a second through hole 16d is centrally formed for mobility of the checker arm 14.

Each slider 20, as shown in FIG. 2, integrally includes hitching protruders 20b formed at both ends of main body part 20a to provide width-wise support for the checker arm 14. Also, a support protruder 20c is formed at the length-wise center of the main body part 20a in a convex shape to provide a staccato feeling for maintenance of an optimum level of tension when the checker arm 14 passes the extension part 14a to be accommodated into the groove part 14b. Therefore, the elastic guide member 16 enables the checker arm 14 to pass through the second through hole 16d when the door is opened or closed. Since the support protruder 20c passes the extension part 14a and groove part 14b of the checker arm 14, it is possible to apply a staccato feeling necessary for controlling a predetermined angle of the opened or closed door and to maintain an optimum level of tension, thereby continuously keeping the door opened at the predetermined angle.

However, there is a problem in the prior art in that the first and second housing plates 16a, 16b are respectively press-molded, and particularly, the second housing plate 16b is processed by a deep drawing method to thereby resulting in inaccurate production where there is a volumetric difference in the internal space formed with the first housing plate 16a. If there occurs irregularity at the size of the internal space of the elastic guide member 16, the cushion members 18 and sliders 20 do not assemble properly nor function well.

Generally, grease is applied over the checker arm 14 to reduce abrasion with the elastic guide member 16. However, if the internal space of the elastic guide member 16 is not sized as per specification, the cushion member 18 and slider 20 may be tightly squeezed and rub in the elastic guide member 16 to thereby increase friction with the checker arm 14, requiring greater operational force. Particularly, if grease applied to the checker arm 14 dries up earlier than a normal replenishment period, there is generated noise when the door is opened or closed.

On the other hand, if the internal space of the elastic guide member 16 is formed larger than an originally specified size, the slider 20 vertically moves and simultaneously rotates inside the elastic guide member 16 to bring about an abnormal noise.

Therefore, it is necessary to take a great care in obtaining precision in manufacturing the elastic guide member 16 of the door checker 10, but it is impossible in reality to test all the products, making it difficult to obtain stability in manufacturing good quality products.

### SUMMARY OF THE INVENTION

The present invention provides a vehicular door checker structure with a slider elastically supporting a checker arm inside an elastic guide member when the door is opened and closed wherein the slider may change shape to accommodate variations in the crosswise and length-wise dimensions of the slider continuously, thereby improving ease of asembly and reliability.

According to a preferred embodiment of the invention, there is provided a vehicular door checker structure, the structure having a mounting bracket screwed onto a vehicle body, a checker arm rotatively coupled onto the mounting bracket and an elastic guide member movably accommodating the checker arm and mounted therein with a slider resiliently supported via a cushion member for coupling to a door in order to resiliently support the checker arm to provide a staccato feeling when the door is opened or closed. The slider integrally comprises: a hitching protruder for width-wise support of the checker arm at both ends of main body; a support protruder formed at the length-wise center of the main body in a convex shape to be accommodated into a groove part of the checker arm; and a damping slot formed through the length of the body along the height of the member at both ends thereof.

In a further alternative embodiment, the present invention comprises an apparatus that includes a resilient member having a length, a width and a height. The reslient member itself comprises a main body portion and two end portions. The main body portion has two opposite ends facing in the width-wise direction, two opposite sides facing in the length-wise direction and upper and lower surfaces. The upper surface is angled upward to form a width-wise protrusion and the main body portion further defines width-wise slots adjacent each side. The two end portions are integrally formed, one at each end of the main body portion, and extend above the upper surface and below the lower surface. Preferably the sides of the resilient member main body portion further define stabilizing protrusions and the end portions each have end surfaces opposite the main body portion defining height-wise reliefs.

Such a resilient member may further comprise a component of an apparatus forming a door checker structure according to the invention. An embodiment of such a structure comprises a bracket member, a vehicle door checker arm, two cushion members and two of the resilient members. The bracket member defines an internal space with an opening therethrough. The vehicle door checker arm extends through the opening and divides the internal space into upper and lower parts. First and second cushion members are disposed in the internal space above and below the checker arm. A reslient member is disposed in each of the upper and lower parts of the internal space, between the checker arm and the associated cushion member with its width-wise main body protrusion contacting the checker arm.

### BRIEF DESCRIPTION OF THE DRAWINGS

For fuller understanding of the nature and object of the invention, reference should be made to the following detailed description taken in conjunction with the accompanying drawings in which:

FIG. 1 is a cross-sectional view illustrating a door checker structure installed at a door of a conventional vehicle;

FIG. 2 is a perspective view illustrating the slider shown in FIG. 1;

FIG. 3 is an exploded perspective view illustrating the structure of an elastic guide member of a door checker in accordance with the present invention;

FIG. 4 is a perspective view illustrating the slider shown in FIG. 3; and

FIG. 5 is a plan view illustrating the slider shown in FIG. 4.

### DETAILED DESCRIPTION OF THE INVENTION

Hereinafter, preferred embodiments of the present invention will be described in detail with reference to accompanying drawings.

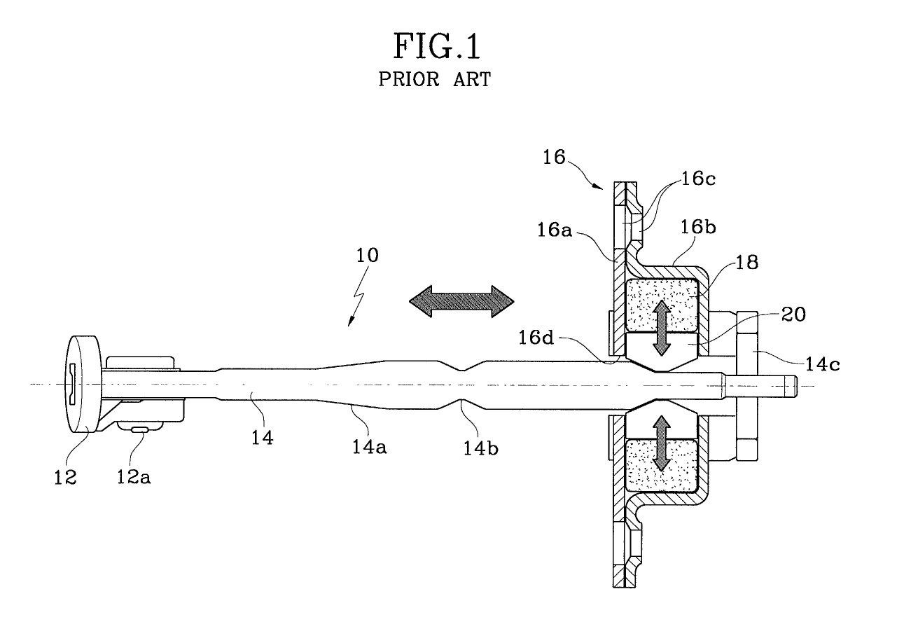

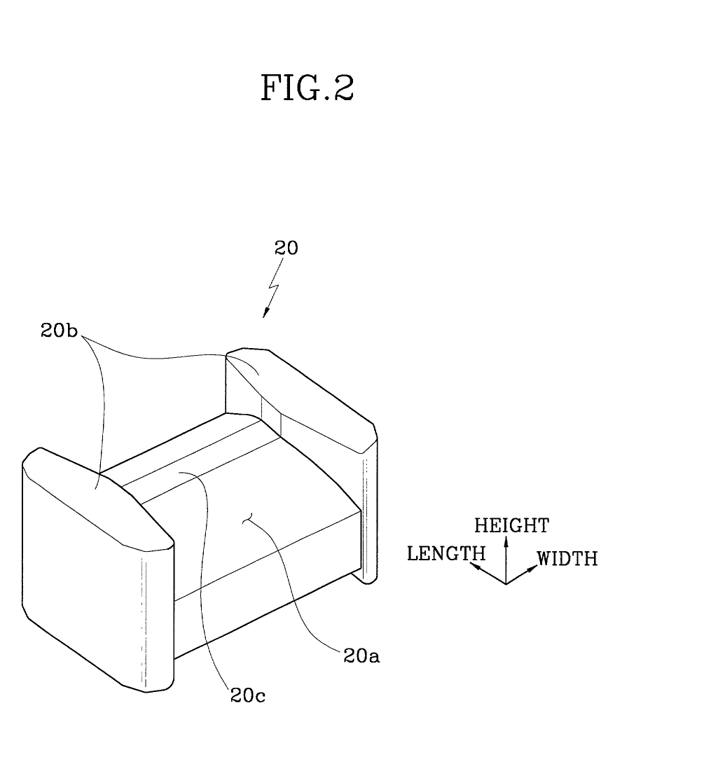

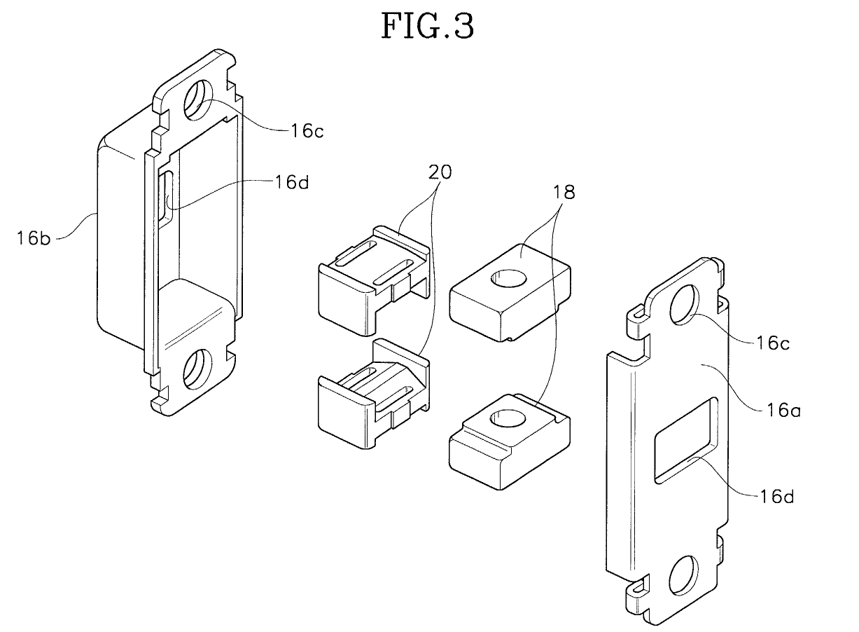

In general, the present invention employs a door checker structure as shown and described in FIG. 1. More specifically, as shown in FIG. 3, the elastic guide member 16 according to the invention includes a first housing plate 16a with surface thereof being attached to the internal side of an internal panel of the door and a second housing plate 16b with top and bottom sides thereof being attached to the first housing plate 16a and center thereof being upwardly bent to form a space of predetermined size. Also, resilient cushion members 18 are arranged at the top and bottom portions of the internal space formed by the first and second housing plates 16a, 16b, and sliders 20 are respectively placed at the internal center of the resiliently supporting cushion members 18.

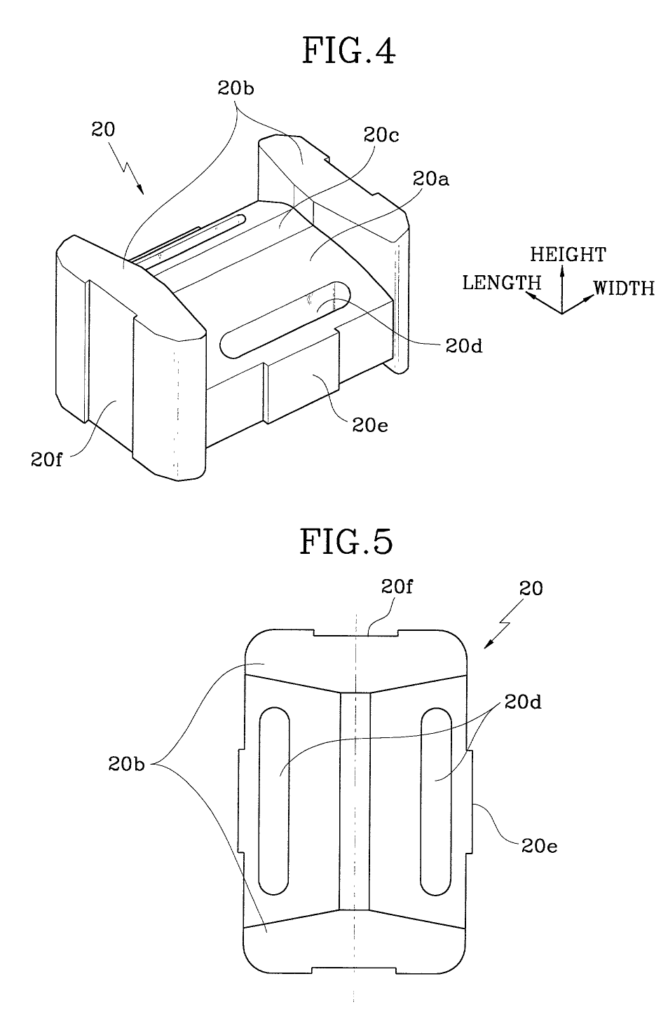

In a preferred embodiment of the invention, the slider 20, as shown in FIGS. 4 and 5, includes hitching protruders 20b at both ends of its main body 20a to support the width of the checker arm 14. A support protruder 20c is formed at the length-wise center of the main body 20a in a convex shape to provide the staccato feeling for maintenance of an optimum level of tension when the checker arm 14 passes the extension part 14a to be placed into the groove part 14b.

Also, according to the invention the slider 20 includes damping slots 20d formed length-wise at both sides of the main body 20a and elastic protruders 20e extending out of the damping slots 20d at both sides of the main body 20a. Slider 20 also has a partly cut groove part 20f shaped along central back of the hitching protruder 20b.

Therefore, even if there occurs a volumetric difference in the internal space due to manufacturing tolerances or errors in the first and second housing plates 16a, 16b, the damping slots 20d permit the slider to compress easily to accommodate such variations when placed to normally receive the sliders 20 inside the elastic guide member 16. Thus, abrasion generated by the sliders 20 and the cushion members 18 being squeezed inside the elastic guide member 16 and a rise in operational force generated by operation of the door checker 10, can be prevented.

Also, if the length-wise space between the first and second housing plates 16a, 16b is broadly formed, the elastic protruder 20e, externally formed at both ends of the main body part 20a, can prevent the slider 20 from slightly rotating in the elastic guide member 16 when the door checker 10 is in operation. In other words, the elastic protruder 20e elastically contacts the internal wall of the elastic guide member 16 to prevent rotation of the slider 20 in the elastic guide member 16.

Furthermore, the partly cut groove part 20f, formed at both ends of the main body part 20a, provides room for the slider 20 to slightly decrease as the internal space of the elastic guide member 16 gets smaller. Therefore, it becomes possible to actively cope with width-wise manufacturing tolerances or errors in the elastic guide member 16.

As described above, even if the internal space of the elastic guide member 16 is manufactured in larger or smaller size than that of the specification due to manufacturing tolerances or errors, there occurs no excessive contact between the checker arm 14 and slider 20 as the greased checker arm 14 contacts the slider 20 elastically supported via the cushion member 18 in the elastic guide member 16 when the door is opened or closed. As a result, there is generated no noise in opening or closing of the door even when grease coated on the checker arm 14 is prematurely dried up. Also, the door checker can be manufactured with reliable quality without going through a full test of products to enable to secure precision in manufacturing the elastic guide member 16.

As described above, there are advantages in the vehicular door checker structure thus described according to the present invention in that, even if the internal space of the elastic guide member 16 of the door checker 10 is irregularly manufactured, the slider 20 to be accommodated in the elastic guide member 16 is shaped to allow itself to slightly accommodate length-wise and width-wise changes, thereby enabling the elastic guide member 10 to perform a normal, smooth function when the door checker 10 is in operation.

What is claimed is:

1. A vehicular door checker structure, the structure having a mounting bracket adapted to be screwed to a vehicle body, a checker arm rotatively coupled onto the mounting bracket and an elastic guide member movably accommodating the checker arm and mounted therein with a slider resiliently supported via a cushion member for being coupled to a door in order to resiliently support the checker arm for providing a staccato feeling when the door is opened or closed, wherein the slider integrally comprises: a hitching protruder for supporting the width of the checker arm at both ends of main body; a support protruder formed at the length-wise center of the main body in the convex shape to be accommodated into the groove part of the checker arm; and a damping slot formed through the length of the body along the height of the member at both ends thereof.

2. The structure, as defined in claim 1, wherein the slider integrally comprises elastic protruders, each protruding height-wise along an external side formed with a damping slot.

3. The structure, as defined in claim 1, wherein the slider integrally comprises a partly cut groove part shaped along central back height of the hitching protruder.

4. An apparatus, including a resilient member having a length, a width and a height, and comprising:
a main body portion with two opposite ends facing in the width-wise direction, two opposite sides facing in the length-wise direction and upper and lower surfaces, the upper surface being angled upward to form a width-wise protrusion and the main body portion further defining width-wise slots adjacent each side; and
two end portions, one integrally formed at each end of the main body portion and extending above said upper surface and below said lower surface.

5. The apparatus of claim 4, wherein said sides of the resilient member main body portion further define stabilizing protrusions.

6. The apparatus of claim 5, wherein said end portions of the resilient member each have end surfaces opposite the main body portion, said end surfaces defining height-wise relief.

7. The apparatus of claim 4, further comprising:
a bracket member defining an internal space with an opening therethrough;
a vehicle door checker arm extending through said opening and dividing said internal space into upper and lower parts;
first and second cushion members disposed in said internal space above and below said checker arm; and
two of said resilient members, one each disposed in said upper and lower parts of the internal space between the checker arm and one cushion member with said widthwise main body protrusion contacting the checker arm.
